(19) United States
(12) Patent Application Publication
(10) Pub. No.: US 2009/0086484 A1
(43) Pub. Date: Apr. 2, 2009

(54) SMALL FORM FACTOR DOWNLIGHT SYSTEM

(76) Inventor: Stephen G. Johnson, Newburyport, MA (US)

Correspondence Address: EDWARDS ANGELL PALMER & DODGE LLP, P.O. BOX 55874, BOSTON, MA, 02205, US

(21) Appl. No.: 11/863,985

(22) Filed: Sep. 28, 2007

(51) Int. Cl. F21V 11/00

(52) U.S. Cl. 362/236

(57) ABSTRACT

A downlight system includes a substrate. One or more light emitting diodes are disposed on a surface of the substrate for emitting light in a single direction. A respective primary optic for providing a substantially even color of light is optically coupled to a respective one of each of said one or more light emitting diodes.

### CROSS-REFERENCE TO RELATED APPLICATIONS

This Application claims the benefit of U.S. Provisional Application No. 60/666,103 filed on Mar. 29, 2005, entitled SMALL FORM FACTOR LED DOWNLIGHT SYSTEM WITH ADJUSTABLE SECONDARY OPTICS, and is a Continuation-in-part of application U.S. Ser. No. 06/11,771 filed on Mar. 29, 2006, entitled SMALL FORM FACTOR DOWNLIGHT SYSTEM the disclosures of which are hereby incorporated by reference in their entirety.

### BACKGROUND OF THE INVENTION

This invention is directed to a downlight system, in particular a downlight system making use of light emitting diodes (LEDs) to produce light in a smaller form factor.

Reference is first made to FIG. 1 where a schematic diagram of a downlight as known in the art is provided. Downlights 100 are luminaires and include housings 102 having sufficient height that they are recessed into ceilings 106 and project light in the downward direction of arrow A towards the floor. Downlights 100 currently use a number of different lamp types 104, as is known in the art; namely incandescent, halogen, compact fluorescent and metal halide light sources. All prior downlights have a common construction utilizing a single light source, or in some cases, compact fluorescent luminaires utilize two light sources, whose emitted radiation is focused downward by a reflecting element, either within the housing 102 or within the bulb 104. For aesthetic purposes, ceiling lights are desired to be flush with ceiling 106. Accordingly, because of the space requirement of housing 102, housing 102 projects up into ceiling 106 when luminaire 100 is flush with ceiling 106 requiring a space of many inches above the ceiling to accommodate the height of the housing 102.

The electrical connection is made to the luminaires in the space above ceiling 106. The efficiency of these luminaires varies, depending greatly on the reflective element. The conventional sources emit light in a spherical pattern, 4 pi steradians, requiring the reflector design to refocus the light emitted thereon, in the direction of Arrow A through fixture opening 108. These luminaires have been satisfactory, however, they are large, cumbersome, and highly energy inefficient.

Accordingly, a downlight luminaire for overcoming the shortcomings is desired.

### BRIEF SUMMARY OF THE INVENTION

A downlight system includes a substrate. One or more light emitting diodes are disposed on a surface of the substrate for emitting light in a single direction. A respective primary optic for providing a substantially even color of light is optically coupled to a respective one of each of said one or more light emitting diodes.

In one embodiment of the invention, each of the light emitting diodes is formed as a die-package, the primary optics including a lens, the lens being matched to minimize the refractive index as a function of the angle of the emissive distribution of light from the LED. In another embodiment, the primary optics includes a phosphor layer. In another embodiment of the invention, the primary optics includes a high refractive encapsulate material within the die-package.

The substrate may be formed of thermally conductive material to act as a heat sink. A trim ring is disposed about the substrate. The trim ring provides both aesthetic attributes and function. In one embodiment, the trim ring is formed of a thermally conductive material to act as an ancillary heat sink.

A secondary lens is provided along the light path of the LEDs to control the beam spread of the light emitted from the downlight system. The lens may be a non-imaging lens.

### BRIEF DESCRIPTION OF THE DRAWINGS

For a fuller understanding of the invention, reference is had to the following description taken in connection with the accompanying drawings:

FIG. 1 is a schematic view of a downlight fixture in accordance with the prior art;

FIG. 2 is an exploded perspective view of a downlight fixture in accordance with the invention;

FIG. 3 is a side elevation sectional view of a pair of LEDs disposed on a substrate in accordance with the invention;

FIG. 4 is a perspective view of a downlight fixture constructed in accordance with the invention;

FIG. 5 is a side elevational view of a downlight fixture constructed in accordance with the invention;

FIG. 6 is a first circuit diagram of the downlight fixture constructed in accordance with the invention;

FIG. 7 is a second circuit diagram of the downlight fixture constructed in accordance with the invention;

FIG. 8 is a schematic view of the downlight fixture mounted to the ceiling in accordance with the invention;

FIG. 9 is the downlight fixture mounted to the ceiling in accordance with a second embodiment of the invention;

FIG. 10 is a side elevation sectional view of a pair of LEDs disposed on a substrate in accordance with the invention; and

FIG. 11 is a schematic view of a downlight fixture in accordance with another embodiment of the invention.

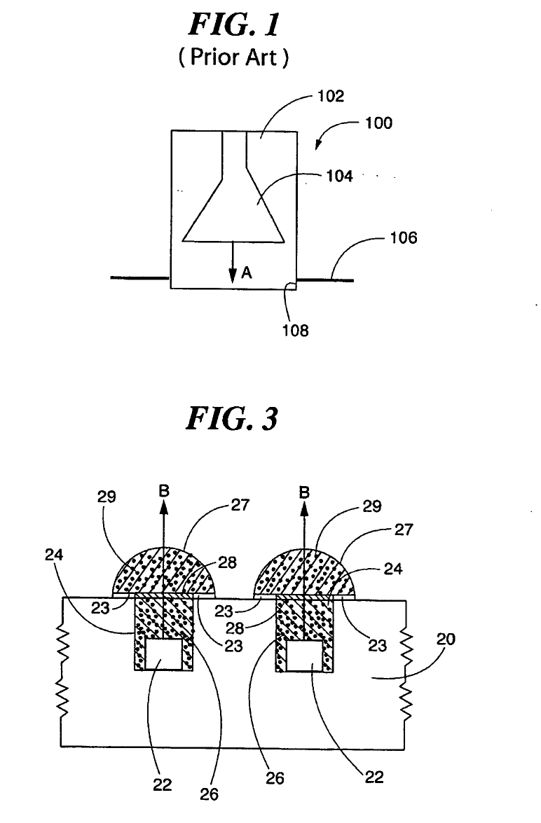

### DETAILED DESCRIPTION OF THE INVENTION

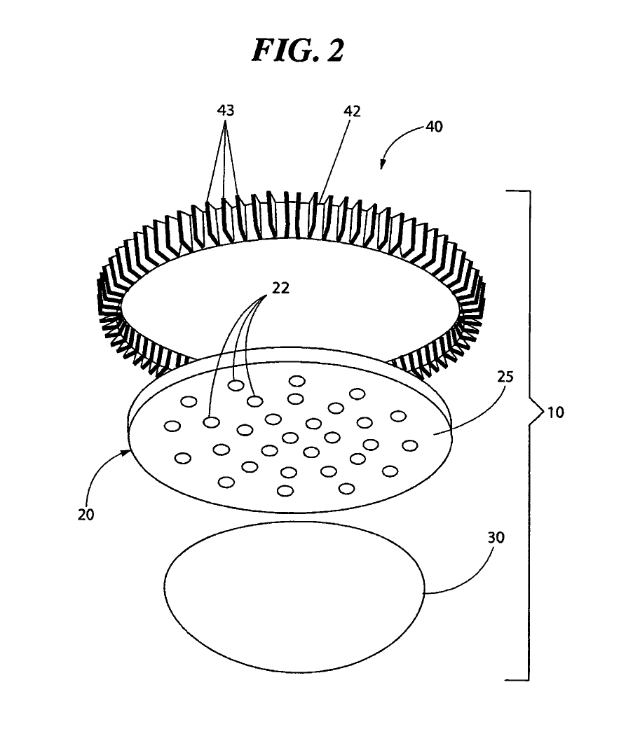

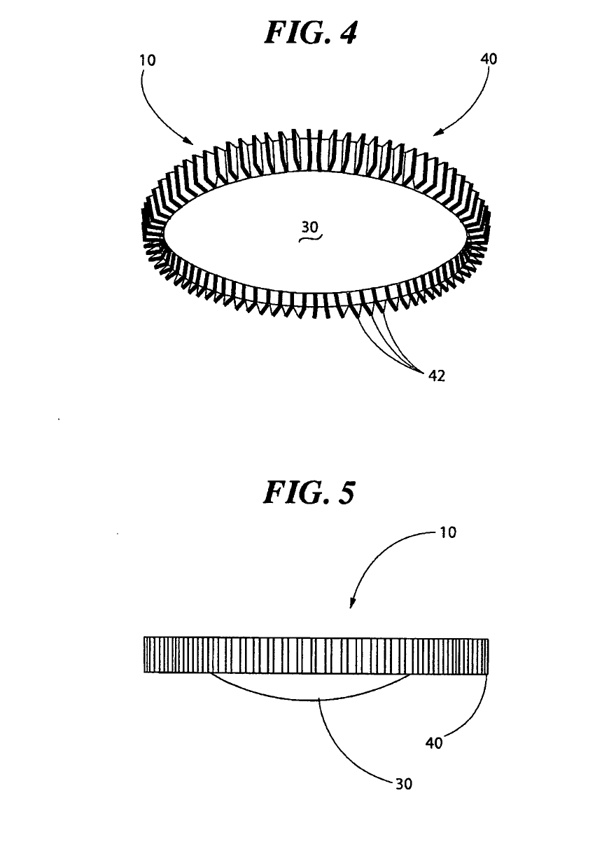

Reference is made to FIG. 2 in which an LED downlight system, generally indicated as 10, constructed in accordance with the invention, is provided. Downlight system 10 includes a substrate 20. Substrate 20 has a downward facing surface 25. A plurality of light emitting diodes 22 are disposed on downward facing surface 25 and oriented to project light in a direction away from surface 25. In a preferred embodiment, substrate 20 is made of a thermally conductive material to act as a heat sink to dissipate heat generated by the one or more LEDs 22.

Each of LEDs 22 is formed as a die as shown in FIG. 3. LEDs 22 are disposed within an optical cavity 24 formed within substrate 20. In a preferred embodiment, a high refractive encapsulant 26 is disposed within optical cavity 24 encapsulate LED 22. In a preferred embodiment, the high refractive encapsulant 26 has an index of refraction greater than about 1.5. The encapsulant may be a silicon gel, by way of non-limiting example, having an index of refraction greater than 1.5.

LEDs 22, as known in the art, do not emit white light. They most commonly emit red, green and blue, and are capable of emitting other colors such as amber. Therefore, to produce white light, LEDs 22 may be formed in patterns of red, blue, green to combine for a white light effect. However, in a preferred embodiment, a phosphor diffuser layer 928 is disposed across an opening in optical cavity 24 downstream of the path of light as indicated by Arrow B. It should be noted that other color LED amber may be combined to soften the color of the emitted light. By mixing and matching the LED colors or using a diffuser layer 928 with a phosphor coating thereon, the possibility for an LED assembly that can emit a single color or a variety of colors is present.

The light that is emitted from the optical cavity 24 is focused by two elements; a primary lens 27 and the reflective surface 23 under the primary lens 27. In a preferred embodiment, lens 27 is matched to the function of the angle of the emissive distribution of light from phosphor layer 28, or in the absence of phosphor layer 28, from the reflector to minimize internal reflections.

In a preferred embodiment, lens 27 defines a volume between lens 27 and a respective LED 22. A second high refractive index encapsulant 29 is disposed in the volume defined by lens 27. In a preferred, non-limiting example, the lens 27 is a substantially hemispherical, substantially transparent, lens in order to maximize light transmission and reduce reflection. The reflector and lens 27 are optimized for the emissive distribution pattern of the LEDs.

In the preferred embodiment, LED 22 is optically coupled with high refractive index encapsulants 26, 29, phosphor diffuser layer 28, and lens 27. However, it is well within the scope of the invention to provide a downlight without one or more of these structures associated with the LED. Therefore, the structures are collectively and individually referred to as the primary optics for creating a substantially even color of light across LEDs 22. Additionally, a common lens 27, and associated gels and phosphor layers may be associated with two or more LEDs 22, and two or more LEDs may be disposed in a single optical cavity. Furthermore, LEDs 22 may be formed as die-packages mounted to substrate 20, rather than optical cavities formed within substrate 20; both being considered disposed on the substrate.

Secondary lens 30 is used as an additional optical element. Secondary lens 30 may serve to further diffuse the light from the individual LEDs 22, or it may provide additional optical control to the light emitted from the assembly of LEDs 22.

In a first embodiment, secondary lens 30 is a non-imaging lens utilizing the principles of non-imaging optics to generate a desired light distribution. As known in the art, non-imaging optics incorporates the calculation of free form surfaces, which redistributes light. Such non-imaging optics are known in the art; provided by OEC by way of example.

The secondary lens 30 can further diffuse the light or enhance a uniform light color output by mixing different colored light output by the individual LEDs 22 of different color distributions as visible white light.

Furthermore, by interchanging a plurality of secondary lenses 30, the beam spread of the light may be changed from a straight beam (spotlight) to a wide beam (Gaussian) distribution. In such a way, adjustable beam spread is provided by secondary lens 30.

Lastly, secondary lens 30 can control the output from the LEDs 22 to reduce or eliminate veiling glare, improving the aesthetics of the fixtures when viewed from below.

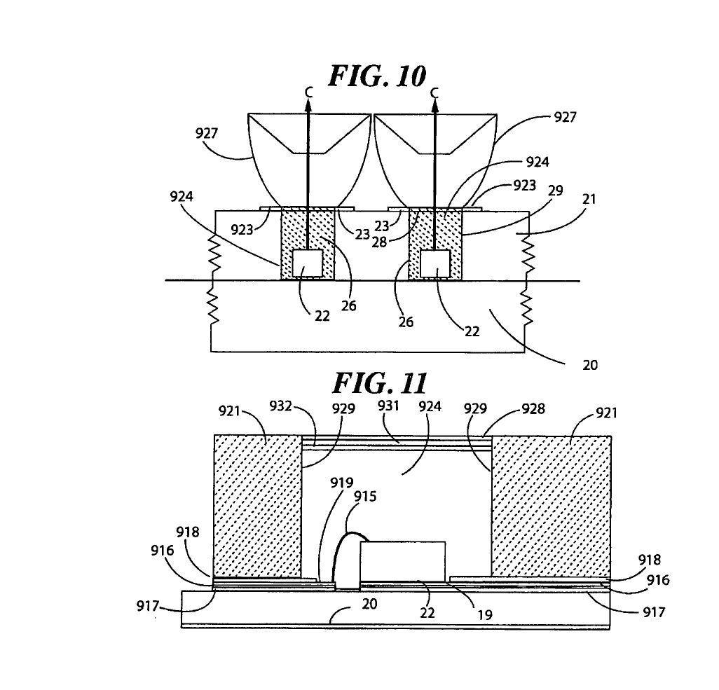

Reference is now made to FIG. 10 in which an alternative embodiment, generally indicated as 900 is provided. Like numerals are utilized for like structure. The substrate 920 is a rigid support for the overlaying structures and provides alignment of these structures. In FIG. 10, one or more thin conductive wires or traces 916 are located on surface 925 of substrate 20 to make the electrical contacts to the LED 22. If substrate 20 is electrically conductive, a thin dielectric 917 will be placed between the conductive wires and substrate 20 to avoid electrical contact. A thin dielectric reflective coating 918 may be placed over the surface 925 and the associated wires to act as protective coating and to enhance the reflection of light within the optical cavity. This coating will not cover the contact pads 919 needed to make electrical contact to the LED 22.

As discussed above, in a preferred embodiment, substrate 20 is composed of a metal having a high thermal conductivity to maximize thermal dissipation of the heat generated by the LED die 22 during operation. The very thin dimension and thermal conductivity of the contact pads 919 and underlying dielectric 917 provide very low resistance in the thermal path between the LED 22 and substrate 20, which acts as a heat sink.

Rigid substrate 20 can also be constructed using a thermally conducting polymer, manufactured by Cool Poly, or a graphite material such as (PYROID® HT Pyrolytic Graphite Thermal Spreaders) that could be substituted for the metal substrate.

Each of LEDs 22 is formed as a die as shown in FIG. 10, LEDs 22, as discussed above, do not emit white light. They most commonly emit red, green, blue and Ultra Violet (UV), and are capable of emitting other colors such as amber. Therefore, to produce white light, LEDs 22 may be formed in patterns of red, blue, green to combine for a white light effect. However, in a preferred embodiment, a phosphor/diffuser film 928 is disposed across an opening in optical cavity 24 downstream of the path of light as indicated by Arrow C. It should be noted that other color LEDs may be combined to modify or improve the color quality of the emitted light. By mixing and matching the LED colors or using a diffuser layer 928, the possibility for an LED assembly that can emit a single color or a variety of colors is present.

LEDs 22 are disposed within a cylindrical optical cavity 924 formed within lens base 21. The construct of the plastic lens base 21 provides alignment relative to the LED die 22, the diffuser film 928 and the primary lens 927. The angle of the wall 929 of the optical cavity 924 is vertical to, or within 10 degrees of perpendicular to the surface of substrate 20. The wall 929 of the optical cavity 24 is highly reflective having a reflectance exceeding 92% achieved by a vapor deposited coating or using a lining of highly reflective material, such as Vikuiti by 3M or Miro by Alanod Aluminum.

A preferred design for focusing light from the source maximizes luminance in the smallest circular dimension. The height and diameter of the cylindrical optical cavity 924 is dimensioned to reduce the diameter of the diffuser film 928 while providing uniform illuminance of film 928 surface. The diameter of the optical cavity 924 will be limited by the maximum dimension of the LED die 22 and any wire bond 15 connections. In one preferred embodiment, optimization of the dimensions of optical cavity 924 for an LED 22 provide a lambertian or near lambertian distribution as measured in a medium of refractive index of 1.5 when the height to diameter (aspect) ratio of the cylindrical optical cavity 924 is between 0.8 and 1.2, with a preferred ratio of 1.0.

The embodiment works for all types of LEDs but performance can be enhanced by use of LEDs that have no external wire connections, i.e. flip-chip LEDs 22, allowing a smaller cavity diameter. An additional consequence of a smaller luminous surface is a corresponding reduction in the size of the primary lens 927, which is an advantage geometrically and materially. The height of the cavity is dictated by the criteria of uniform illuminance on the surface of the phosphor/diffuser film 928. This height will be dependent on angular distribution of the radiation from the LED die 22.

The diffuser film 928 that caps the top of the optical cavity 924 in the preferred embodiment is circular and is of the same diameter as the optical cavity 924; however, larger geometries may be employed. The diffuser film 928 acts as a diffuser when the color of the LEDs 22 is desired as the emitted light. The diffuser film 928 is the carrier medium for phosphors that emit a broader spectrum of light when excited by blue or UV LEDs 22 for embodiments that project white light directly from optical cavity 924.

The optical cavity 924 provides a uniform illuminance on the surface of diffuser film 928 facing the LED die 22. When cavity 924 is substantially cylindrical, film 925 is substantially a disc. When diffuser film 928 is used as a diffuser with colored die, the diffuser film 928 surface facing the primary lens 927 will radiate as a disc with uniform intensity at the focal point of the primary lens 927 optimizing the performance of the optics.

Where diffuser film 928 is a phosphor layer, the optical cavity 924 provides a uniform illuminance on the surface of phosphor film 928 facing the LED die 22. When film 928 is used as a carrier medium for the phosphors, the phosphor will be exposed with a uniform intensity of excitation radiation. Diffuser film 928 having a uniform dispersion of phosphor will radiate with uniform intensity and color at the focal point of the primary lens 927.

It is common with current practice of coating the phosphor directly onto the die and/or in the medium surrounding the die with the result that there is a nonuniform color emitted by the system when viewed in two-pi steradian. The described system provides a mechanism to achieve a much more uniform color which is unique compared to the prior art. The uniform illuminance of the disc geometry of phosphor film 928 in this embodiment provides this attribute.

In a preferred embodiment, the uniformity of color and intensity from the phosphor film 928 is dependent on the uniformity of the dispersion within the film 928. The film 928 is made as a homogeneous dispersion of phosphors in a transparent carrier. The carriers composed of silicone or organic polymers are possible. Phosphor materials used include Yttrium Aluminum Garnets (YAG), Terbium Aluminum Garnets (TAG), Silicates and Sulfides. Nano-phosphors would work equally as well within this embodiment. The dispersion can contain one or more phosphors to provide different colors and spectral characteristics of white light, such as color temperature and color rendering.

In a preferred embodiment, the diffuser film 928 may be composed of more than one film. The films are layered with no air gap between them. Phosphors that radiate at longer wavelengths, i.e. red, absorb light in the blue but may also absorb longer wavelengths, i.e. green, that are radiated by a different phosphor in the system. Separating the phosphors into different films can reduce absorption of radiation of one phosphor by another, improving performance. Ordering of the films is important, different ordering will have an effect on the color characteristics and efficacy of the radiation from the film 928. The preferred embodiment would order the layers of diffuser film 928 closest to the LED 22 progressing from the longest wavelength emitting phosphors to shortest wavelength emitting phosphors. An additional advantage to the use of multiple layers of phosphors is the ease with which different color characteristics can be achieved within the manufacturing process, the ease of use of using different types of phosphors that may require different carrier chemistries.

The phosphor concentration dispersed within film 928 may be dictated by the type of LED 22 used to excite the phosphors. Film 928 designed for use with a UV LED 22 will require a phosphor concentration that absorbs all of the impinging UV radiation. A diffuser film 928 designed for use with a Blue LED 22 will use lower concentrations of phosphor to allow the prescribed intensity of blue radiation to be transmitted through the film.

Phosphor coated diffuser film 928 excited by a blue LED 22, having a uniform dispersion of phosphor, will radiate in the direction toward the primary lens 927 with uniform intensity and color for both the blue light from the LED 22 and for the light emitted by the phosphor. The angular distribution of the blue light and the phosphor light from this surface of diffuser film 928 is generally different. The primary lens 927 is designed to correct for this difference. The primary lens 927 projects a focused beam of light that spatially has uniform intensity and color in the far field.

The displacement of the diffuser film 928 from the LED die 22 has additional advantages in that the phosphors are sensitive to temperature, decreasing in performance with increasing operating temperature. The remote location of the diffuser film 928 serves to maintain the phosphor at a lower temperature optimizing system performance.

An anti-reflective (AR) coating 931 can be applied to the diffuser film 928 surface facing the die. It serves to efficiently transmit the short wavelength light from the LED die 22 and reflect longer wavelength light emitted by the phosphor. The AR coating 931 helps significantly in providing a reflective element that significantly reduces transmission of the light from the diffuser film 928 back into optical cavity 924 where it can be absorbed by any or all of the elements in optical cavity 924 including the LED die 22. However, AR coating 931 is a performance-enhancing element that may be omitted from the device in some embodiments.

In a preferred embodiment, a high refractive encapsulant 26 is disposed within optical cavity 924 encapsulating LED 22 to provide environmental protection to the die and the optical cavity materials. In a preferred embodiment, the high refractive encapsulant 26 has an index of refraction greater than about 1.5 to enhance light extraction from the die. The encapsulant may be a silicon gel, by way of non-limiting example, having an index of refraction greater than 1.5.

If optical cavity 924 is not filled with a high refractive index encapsulant 26 but left empty, optical elements like moth-eye films form WaveFront Technology can be used upstream to the AR coating 931 to provide less reflection at the surface of the AR coating 931 and enhance efficiency.

The primary lens 927, integral to the construction of this embodiment, is a non-imaging total internal reflecting (TIR) lens utilizing the principles of non-imaging optics to generate a desired light distribution. As known in the art, non-imaging optics incorporate the calculation of free form surfaces, which redistribute light. Such non-imaging optics are known in the art; as provided by OEC AG, by way of example. The primary TIR lens 927 is aligned with the diffuser film 928 with structures in the lens base 21 and the lower geometry of the primary lens 927. Where lens 927 meets lens base 21 the lens based facing the surface of lens base 21 may be coated with a reflective coating 923 to enhance performance. Primary lens 927 is designed specifically for the diameter of the radiant diffuser film 928 covering optical cavity 924. Primary lens 927 mixes the radiation from diffuser film 928 such that the emission from the lens in the far field is a uniform color across the field and uniform radial intensity.

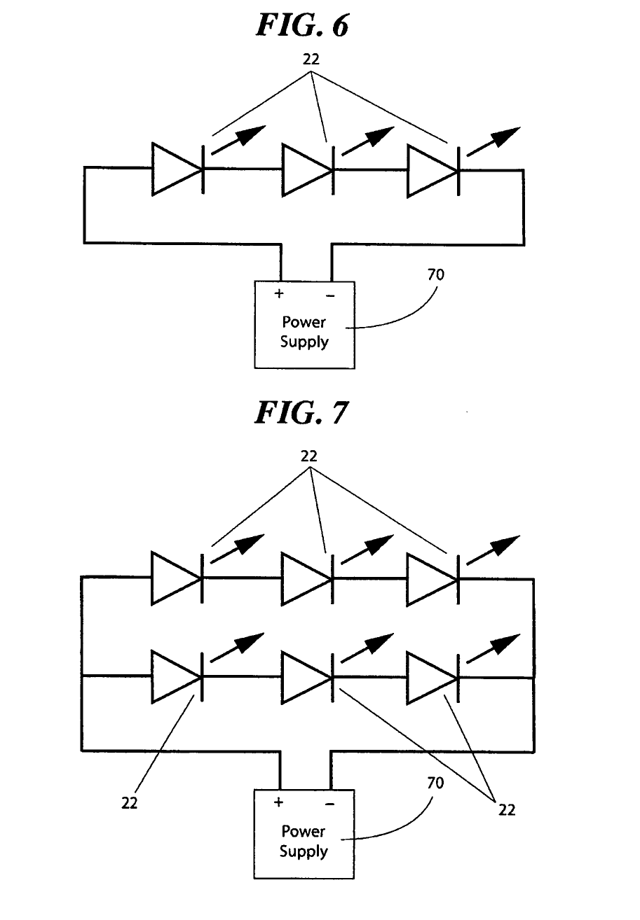

LEDs 22 are low voltage direct current devices. As such, the power source will convert the supplied power from AC to a predetermined DC voltage potential. The power supply design may be either a voltage limiting or current limiting circuit. In a preferred embodiment, LEDs 22 are arrayed in a pattern to control the current by matching the voltage of the power source. If LEDs 22 are in parallel with the power supply 70 (see FIG. 6), the voltage is lowered. If LEDs 22 are in series with the power supply 70 (see FIG. 7), then the current can be lowered. It should be noted that the power source may be independent of downlight system 10 as in conventional wiring structures for light fixtures as known in the art. However, as a result of the compact design as a result of the use of LEDs 22 and substrate 20, the power source or portions of the power source may be incorporated directly into downlight system 10.

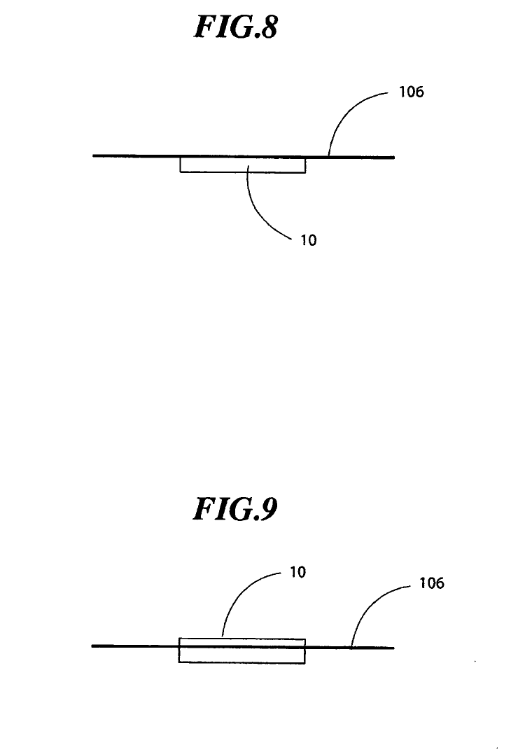

Reference is now made to FIGS. 8 and 9 wherein the manner in which downlight system 10 is mounted is provided. As is readily seen from FIG. 5, as a result of the use of substrate 20 to support the light source, rather than the elongated housing 102 as known in the prior art, downlight system 10 has a substantially planar, thin profile relative to the prior art. Therefore, as seen in FIG. 8, downlight system 10 may be affixed directly to ceiling 106 without need for any recess therein and still provide the aesthetics of being essentially flush with ceiling 106. However, to appear even flusher with ceiling 106, downlight system 10 may be recessed within ceiling 106 as seen in FIG. 9.

Trim ring 40 is disposed about substrate 20 and hides substrate 20 improving the overall aesthetics of downlight system 10. In a preferred embodiment, trim ring 40 is formed of a thermally conductive material and may be provided with radiating fins 42 disposed around the circumference of trim ring 40. In this way, trim ring 40 acts as an ancillary or secondary heat sink to thermally manage the heat generated by the operation of LEDs 22. It is understood that, in lesser-preferred embodiments, active elements such as a fan may be used to dissipate heat by convection. Furthermore, passive heat dissipation structure such as fins 42 may be located on the side of substrate 20 opposite side 25 to hide the heat dissipation structure from view.

By providing an LED downlight system, a light fixture is provided which projects light downward from the ceiling in a fundamentally different form and manner. Because the light sources are much smaller than traditional sources, they may be assembled as an array on a flat substrate. This allows for even distribution of light across the emitting surface of the luminaire. By incorporating small optics associated with each respective LED (light source) to direct the light in the desired direction, the large luminaire conventional design is no longer needed. Therefore, the luminaire can be made to be much thinner, reducing the requirement for a large space above the ceiling. The luminaire may be so thin as to not require penetration of the ceiling at all.

The LED assembly may be powered at a DC voltage allowing ease of wiring both above and below the ceiling surface. A decorative ring or trim ring may be incorporated that cosmetically masks the transition of the ceiling to the luminaire as well as dissipate the heat generated by the LEDs and the heat generated by the power source. If the light source is assembled on a substrate acting as a heat sink, maximum dissipation of the heat of the components is provided while facilitating a thin dimension to the system. Optics may be built into the individual LEDs to provide primary optics of the source while a detachable lens may provide secondary optics providing a variety of light color, beam shape and softness utilizing a simple interchangeable structure.

While this invention has been particularly shown and described with references to the preferred embodiments thereof, it will be understood by those skilled in the art that various changes in form and details may be made therein without departing from the spirit and scope of the invention encompassed by the inventive claims.

What is claimed as new and desired to be protected by Letters Patent of the United States is:

1. A downlight system comprising:
a substrate;
a light source mounted on said substrate, said light source including a plurality of light-emitting diodes and primary optics optically coupled with said light emitting diodes for providing a substantially even color of light; and
an assembly for dissipating heat from the light source.

2. The system of claim 1, further comprising a plurality of optical cavities formed in a plastic lens base, said light emitting diodes being disposed in said plurality of optical cavities, each said optical cavity having an open end.

3. The system of claim 1, wherein said primary optics includes a phosphor layer disposed downstream of light emitted from said light emitting diode.

4. The system of claim 3, further comprising a plurality of optical cavities each having an open end, each light emitting diode being disposed within a respective optical cavity to emit light through the open end, a phosphor layer being disposed across said open end downstream of light emitted from said light emitting diode.

5. The system of claim 2, wherein said primary optics includes a high refractive index encapsulant disposed within said optical cavity substantially encapsulating said light emitting diode within said cavity.

6. The system of claim 1, wherein said primary optics includes a primary lens disposed downstream of the light emitted from said light emitting diode.

7. The system of claim 1, further comprising a plurality of optical cavities formed in said substrate, said light emitting diodes being disposed in said plurality of optical cavities, each said optical cavity having an open end; said primary optics including a phosphor layer disposed across said open end; a high refractive index encapsulant being disposed within said optical cavity substantially encapsulating said light emitting diode; a primary lens disposed downstream of light emitted from said light emitting diode and circumscribing a volume; and a second high refractive index encapsulant disposed within said circumscribed volume.

8. The system of claim 1, further comprising a secondary lens for diffusing light from said light source.

9. The system of claim 8, wherein said secondary lens is a non-imaging lens.

10. A downlight system comprising a substrate, a light source mounted on said substrate, said light source including a plurality of light emitting diodes and primary optics optically coupled with said light emitting diodes for providing a substantially even color of light: and
a plurality of optical cavities, each light emitting diode being disposed within a respective optical cavity
each cavity having an open end, the light emitting diode emitting light through said open end, said primary optics including a phosphor film disposed across said open end, the optical cavity having a wall, the wall extending substantially perpendicularly from the substrate to said open end and being formed as a highly reflective surface.

11. The downlight system of claim 10, wherein an aspect ratio of the wall is between about 0.8 and 1.2.

12. The downlight system of claim 10, comprising an anti-reflection coating disposed between said phosphor film and said light emitting diode.

13. The downlight system of claim 10, further comprising conductive wire leads for electrically connecting the light emitting diode to the substrate.

14. The downlight system of claim 10, further comprising a primary lens disposed downstream of light emitted from said light emitting diode, said primary lens being a non-imaging total internal reflection lens.

15. The downlight system of claim 10, wherein said cavity is substantially cylindrical and said phosphor layer is formed as a disc having a diameter of said cavity.

16. The downlight system of claim 10, further comprising a textured surface film disposed between the phosphor film and the light emitting diode to reduce reflection at the surface of the phosphor layer.

17. A downlight system comprising:
a substrate; and
a light source mounted on said substrate, said light source including a plurality of light-emitting diodes and primary optics optically coupled with said light emitting diodes for providing a substantially even color of light.

18. The system of claim 17, wherein at least one of said light emitting diodes emits light of a first color and at least a second one of said light emitting diodes emits light of a second color, the first color being different from the second color, and the secondary lens, the secondary lens receiving light of at least the first color and the second color emitted by the light emitting diodes and producing a uniform colored light output.

19. The system of claim 17, wherein said plurality of light emitting diodes are arranged to require a voltage equivalent to a voltage supplied by a power source.
